(19) United States
(12) Patent Application Publication
(10) Pub. No.: US 2025/0298595 A1
(43) Pub. Date: Sep. 25, 2025

(54) APPLICATION DISTRIBUTION SYSTEM, MANAGEMENT APPARATUS, AND ADDITIONAL APPLICATION DISTRIBUTION METHOD

(71) Applicant: Mitsubishi Electric Corporation, Tokyo (JP)

(72) Inventors: Saki MIYAI, Tokyo (JP); Koki OMATA, Tokyo (JP); Kanta MIYAMOTO, Tokyo (JP); Taichi ISHIZAKA, Tokyo (JP)

(21) Appl. No.: 18/870,148

(22) PCT Filed: Jun. 20, 2022
(86) PCT No.: PCT/JP2022/024567

§ 371 Date: Nov. 27, 2024

(51) Int. Cl. G06F 8/61; H04L 9/32

(52) U.S. Cl. CPC G06F 8/61; H04L 9/3247

(57) ABSTRACT

An application distribution system includes a management apparatus and a distribution server. The management apparatus manages a facility device used by a facility user. The distribution server is connected to the management apparatus over a network. The management apparatus is configured to perform a standard function to control operations of the facility device, and an additional application is installed therein, the additional application being a function different from the standard function and being configured to perform processing with data on the facility device collected by the standard function. The distribution server is configured to receive the additional application developed by a developer user over a network, and installs the received additional application on the management apparatus.

### TECHNICAL FIELD

The present disclosure relates to an application distribution system, a management apparatus, and an additional application distribution method.

### BACKGROUND ART

A program update method of downloading a program for update from a management server to a client terminal has conventionally been known as a program update method performed by the client terminal in a client-server type system. For example, WO2019/082738 (PTL 1) describes a remote control system where the program update method described above is used.

The management server in PTL 1 updates a program for a hot water supply system for each household. In the hot water supply system for each household, a ROM where a program yet to be updated is stored is divided into a running program storage area and an update program storage area. Thereafter, the hot water supply system in PTL 1 downloads an update program to the update program storage area while a running program is held in the running program storage area. Thus, in the program update method in PTL 1, update of the program in the client terminal for each household is managed by the management server in a centralized manner.

### CITATION LIST

### Patent Literature

PTL 1: WO2019/082738

### SUMMARY OF INVENTION

### Technical Problem

Operations of a facility device such as hot water supply equipment, an air-conditioning device, and a lighting device may be controlled and monitored, for example, by a management apparatus introduced in a building. In other words, the management apparatus that manages in a centralized manner, various facility devices included in a structure such as a building may have been introduced in the structure.

The structure in which such a management apparatus has been introduced may be constructed in various regions. Therefore, climates and environments in regions where the structure is provided are various. In addition, cultures and customs of users who use the structure may be different for each structure. Since the environment where the facility device is used is thus different depending on the region where the structure is provided or a characteristic of a user who uses the structure, functions different depending on the environment may be desired as the functions for management of the facility device by the management apparatus.

The present disclosure was made to solve such a problem, and an object thereof is to provide an application distribution system to distribute to a management apparatus to manage a facility device for each management apparatus, an application that allows expansion of a management function in conformity with an environment where the management apparatus is provided.

### Solution to Problem

An application distribution system in the present disclosure includes a management apparatus and a distribution server. The management apparatus manages a facility device to be used by a facility user. The distribution server is connected to the management apparatus over a network. The management apparatus is configured to perform a standard function to control operations of the facility device, and an additional application is installed therein, the additional application being a function different from the standard function and being configured to perform processing with data on the facility device collected by the standard function. The distribution server is configured to receive the additional application developed by a developer user over a network, and installs the received additional application on the management apparatus.

A management apparatus in the present disclosure is a management apparatus to manage a facility device to be used by a facility user. The management apparatus includes a communication apparatus to communicate with the facility device and a control apparatus. The control apparatus is configured to perform a standard function to control operations of the facility device, and has the additional application installed, the additional application being a function different from the standard function and is configured to perform processing with data on the facility device collected by the standard function.

An additional application distribution method in the present disclosure includes publishing information on control of a standard function to control operations of a facility device to a developer user who develops an additional application to be installed in a management apparatus to perform the standard function, registering the additional application created by the developer user in a distribution server based on control of the published standard function, transmitting to the distribution server, by a facility user who uses the facility device, an installation request for installation of the additional application registered in the distribution server, and installing the additional application in the management apparatus based on transmission of the installation request.

### Advantageous Effects of Invention

According to the present disclosure, an application that allows expansion of a management function in conformity with an environment where a management apparatus to manage a facility device is provided can be distributed to the management apparatus for each management apparatus.

### BRIEF DESCRIPTION OF DRAWINGS

FIG. 1 is a diagram for illustrating a configuration of an application distribution system including a management apparatus.

FIG. 2 is a block diagram showing an internal configuration of the management apparatus.

FIG. 3 is a block diagram showing an internal configuration of a distribution server.

FIG. 4 is a block diagram showing an internal configuration of a developer user terminal.

FIG. 5 is a block diagram showing an internal configuration of a facility user terminal.

FIG. 6 is a flowchart showing a processing for registration of an additional application by the distribution server.

FIG. 7 is a flowchart showing processing for purchase of the additional application by the facility user terminal.

FIG. 8 is a flowchart showing processing for installation of the additional application by the distribution server.

FIG. 9 is a flowchart showing processing for installation of the additional application by the facility user terminal.

### DESCRIPTION OF EMBODIMENTS

An embodiment of a technical concept according to the present disclosure will be described below with reference to the drawings. The same elements in the description below have the same reference characters allotted and their labels and functions are also the same. Therefore, detailed description thereof will not be repeated.

### Configuration of Application Distribution System

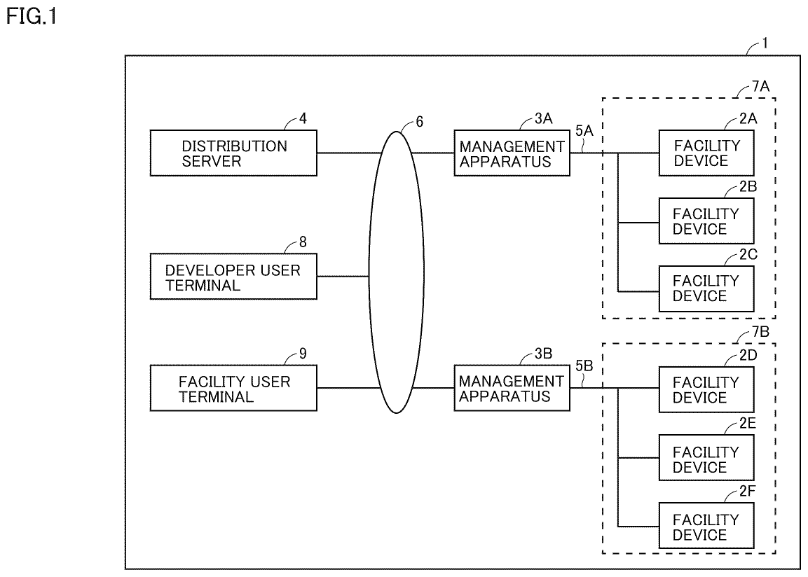

FIG. 1 is a diagram for illustrating a configuration of an application distribution system 1 including management apparatuses 3A and 3B according to an embodiment of this invention. As shown in FIG. 1, application distribution system 1 includes a distribution server 4, a developer user terminal 8, a facility user terminal 9, management apparatuses 3A and 3B, and facility devices 2A to 2F.

Facility devices 2A to 2C will collectively be referred to as a “facility device group 7A” below. Facility devices 2D to 2F will collectively be referred to as a “facility device group 7B.” Facility device group 7A is provided at a position different from facility device group 7B. Facility device group 7A is provided, for example, in a building constructed in a cold region and facility device group 7B is provided, for example, in a building constructed in a warm region. In other words, facility device group 7A and facility device group 7B are provided in different regions.

Facility devices 2A to 2F are various facility devices included in a building, and may be, for example, an air-conditioning device, a lighting device, a hot water supply device, or the like. In the present embodiment, facility devices 2A and 2D are each the air-conditioning device to perform an air-conditioning function, facility devices 2B and 2E are each the lighting device, and facility devices 2C and 2F are each the hot water supply device.

Management apparatuses 3A and 3B manage facility device groups 7A and 7B in a centralized manner, respectively. Management includes control of operations of each facility device and monitoring of an operating state of each facility device. Management apparatuses 3A and 3B are connected to facility device groups 7A and 7B through dedicated communication lines 5A and 5B, respectively. A specific production number is allocated to each of management apparatuses 3A and 3B. For facility device 2A which is the air-conditioning device, management

apparatus 3A can control functions of facility device 2A such as switching between cooling and heating and setting of a temperature. For facility device 2B which is the lighting device, management apparatus 3A can control functions of facility device 2B such as on/off control of lighting and dimming control. Furthermore, for facility device 2C which is the hot water supply device, management apparatus 3A can control functions of facility device 2C such as start of hot water supply and change of a setting temperature of hot water supply.

Facility devices 2A to 2F thus provide various functions such as the air-conditioning function, the lighting function, the hot water supply function, and the like to a user who uses the building. The function performed by each of facility devices 2A to 2F at a time point of introduction in the building is referred to as a “standard function” below. The standard function is a function designed by a manufacturer of facility devices 2A to 2F. A user who manages facility devices 2A to 2F and owns management apparatuses 3A and 3B is referred to as a “facility user” below. A manufacturer of management apparatuses 3A and 3B for management of facility devices 2A to 2F is the same as a manufacturer of facility devices 2A to 2F. Application distribution system 1 in the present embodiment is managed by the manufacturer of management apparatuses 3A and 3B. The manufacturer of management apparatuses 3A and 3B who is also the manager of application distribution system 1 is collectively simply referred to as a “manager” below.

Each of facility devices 2A to 2F collects data generated by fulfillment of the standard function as data indicating an operating state. For example, facility device 2A which is the air-conditioning device collects and holds data indicating a cumulative time period of operations in the past, a setting temperature, and the like. For example, facility device 2B which is the lighting device collects and holds data indicating a duration of ON of lighting in the past, a degree of dimming, and the like. The data indicating these operating states is simply referred to as “operating state data” below. Management apparatuses 3A and 3B obtain the operating state data collected by facility devices 2A to 2C and 2D to 2F, respectively.

Facility devices 2A to 2F may collectively simply be referred to as a “facility device 2” below. Management apparatuses 3A and 3B may collectively simply be referred to as a “management apparatus 3.” Furthermore, dedicated communication lines 5A and 5B may collectively simply be referred to as a “dedicated communication line 5.” Facility device groups 7A and 7B may collectively simply be referred to as a “facility device group 7.”

Management apparatuses 3A and 3B are connected to distribution server 4 through a communication line 6. Distribution server 4 is a server to distribute to management apparatuses 3A and 3B, an additional application to perform a function different from the standard function. Communication line 6 is, for example, the Internet line or the like. The additional application may simply be referred to as an “additional app” below.

Distribution server 4 can communicate with developer user terminal 8 and facility user terminal 9 through communication line 6. Developer user terminal 8 is a terminal to be used by a user who develops an additional application. The user who develops the additional application is simply referred to as a “developer user” below. For example, a general constructor, a building material distributor, an application development company, a researcher in a university, an individual programmer, or the like may fall under the developer user. The facility user himself/herself may develop the additional application. Facility user terminal 9 is a terminal to be used by a facility user. Developer user terminal 8 and facility user terminal 9 are each a general-purpose PC, a smartphone, or the like.

### Configuration of Management Apparatus

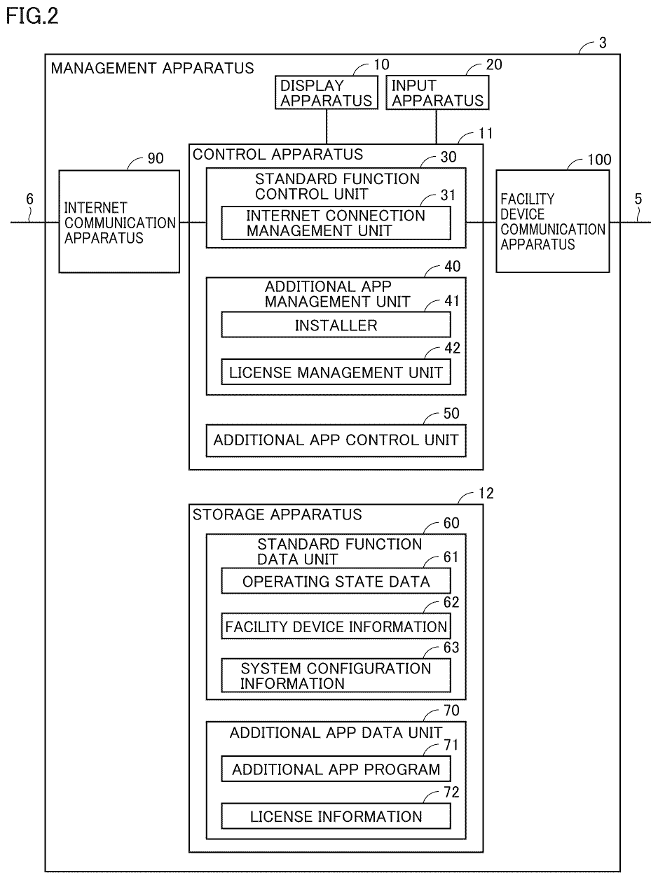

FIG. 2 is a block diagram showing an internal configuration of management apparatus 3. Management apparatus 3 includes a display apparatus 10, a control apparatus 11, a storage apparatus 12, an input apparatus 20, an Internet communication apparatus 90, and a facility device communication apparatus 100.

Display apparatus 10 is implemented, for example, by a liquid crystal display or a display, and shows various types of information. Input apparatus 20 is implemented by a keyboard or a mouse and accepts input from the facility user. Display apparatus 10 and input apparatus 20 may be provided as a touch panel as being integrated. The facility user can operate input apparatus 20 to switch display contents on display apparatus 10. The facility user can use input apparatus 20 and display apparatus 10 to control operations of facility device 2.

Control apparatus 11 includes, for example, at least one central processing unit (CPU) and a memory. In control apparatus 11, various functions are performed by execution by the CPU, of a program stored in the memory. Control apparatus 11 may be configured based on electronic circuitry such as a field programmable gate array (FPGA) or an application specific integrated circuit (ASIC).

Storage apparatus 12 may include a non-transitory (non-volatile) computer readable data recording medium. A recording medium is not limited to a CD-ROM, a flexible disk (FD), or a hard disk, but may be a medium that carries a program in a fixed manner such as a magnetic tape, a cassette tape, an optical disc (a magnetic optical disc (MO)/a mini disc (MD)/a digital versatile disc (DVD)), an integrated circuit (IC) card (including a memory card), an optical card, or a semiconductor memory such as a mask ROM, an electronically programmable read-only memory (EPROM), an electronically erasable programmable read-only memory (EEPROM), and a flash ROM.

Control apparatus 11 includes a standard function control unit 30, an additional app management unit 40, and an additional app control unit 50. Storage apparatus 12 includes a standard function data unit 60 and an additional app data unit 70.

A configuration relating to the standard function of facility device 2 will be described below. Standard function control unit 30 in control apparatus 11 monitors and manages facility device 2 connected to management apparatus 3. In other words, standard function control unit 30 controls facility device 2 to obtain the operating state data.

Standard function control unit 30 includes an Internet connection management unit 31. Internet connection management unit 31 communicates with distribution server 4 through communication line 6. Internet connection management unit 31 receives data on update, correction, or the like of a program for the standard function transmitted from distribution server 4.

Standard function data unit 60 in storage apparatus 12 holds data relating to the standard function of each facility device 2 connected to management apparatus 3. In other words, standard function data unit 60 represents an area in storage apparatus 12 where data relating to the standard function is to be held. Standard function data unit 60 includes operating state data 61, facility device information 62, and system configuration information 63.

Operating state data 61 is data indicating the operating state of facility device 2 described above. Operating state data 61 is collected at predetermined intervals by standard function control unit 30 from each facility device 2 connected to management apparatus 3. In other words, operating state data 61 is added or updated at predetermined intervals.

Facility device information 62 includes a communication scheme, a data structure, and the like for obtaining the operating state data from each facility device 2 connected to management apparatus 3. In other words, since each facility device 2 may include various types of devices, depending on the type of the devices, the communication scheme and the structure of the operating state data are different. In other words, data necessary for communication between management apparatus 3 and each facility device 2 is stored in facility device information 62.

Relation of connection between facility devices 2 is stored in system configuration information 63. In other words, system configuration information 63 includes a network configuration between facility devices 2. Facility device 2A which is the air-conditioning device and facility device 2B which is the lighting device may be connected to each other over the network. As a result of connection between facility device 2A and facility device 2B, in coordination with turn-off of facility device 2B which is the lighting device, facility device 2A can turn off a cooling function or a heating function of the facility device itself. Such relation of connection between facility devices 2 is stored as the network configuration in system configuration information 63.

In succession, a configuration relating to an additional application will be described. Additional app management unit 40 performs management of an additional application, such as installation processing. Additional app control unit 50 executes the installed additional application. In management apparatus 3 in the present embodiment, additional app management unit 40 and additional app control unit 50 edit and write no data stored in standard function data unit 60. In other words, processing performed by additional app management unit 40 and additional app control unit 50 does not directly affect standard function data unit 60.

Additional app management unit 40 includes an installer 41 and a license management unit 42. Installer 41 installs the additional application in response to transmission of an installation command from distribution server 4 to management apparatus 3. Distribution server 4 transmits the installation command to management apparatus 3, with a program for installation of the additional application being incorporated in the installation command. A program for installation and execution of the additional application by management apparatus 3 is simply referred to as an “additional app program” below, and reception of the additional app program by management apparatus 3 is referred to as “downloading”. Additional app management unit 40 has the downloaded additional app program stored in additional app data unit 70.

License management unit 42 in additional app management unit 40 registers a license of the installed additional application in response to transmission of a license registration command from distribution server 4 to management apparatus 3. Distribution server 4 transmits the license registration command to management apparatus 3, with license information indicating permission of use of the additional application being incorporated in the license registration command. For example, a license number that allows execution of the additional application is held in the license information. The license number includes an expiration date until which the additional application is executable and a production number of management apparatus 3 permitted to execute the additional application. License registration in management apparatus 3 refers to storage of the license information received from distribution server 4 in additional app data unit 70 in correspondence with the additional application. Thus, in application distribution system 1, circumstances of installation of the additional application can be checked by checking by the manager of application distribution system 1, of the license information stored in management apparatus 3. For example, the manager of application distribution system 1 can identify the facility user who has purchased the additional application.

Additional app data unit 70 in storage apparatus 12 holds an additional app program 71 which is a program for execution of the downloaded additional application and license information 72 of the additional application. Additional app data unit 70 represents an area in storage apparatus 12 where data relating to the additional application is to be held, similarly to standard function data unit 60.

In the present embodiment, additional app program 71 and license information 72 are transmitted and received between distribution server 4 and management apparatus 3 via a public folder. More specifically, distribution server 4 has additional app program 71 and license information 73 stored in a public folder on a cloud. Thereafter, distribution server 4 transmits a uniform resource locator (URL) of the public folder to management apparatus 3. Management apparatus 3 accesses the URL to obtain additional app program 71 and license information 72. In one aspect, distribution server 4 may directly transmit additional app program 71 and license information 72 to management apparatus 3 without using the public folder.

Installer 41 checks whether or not downloaded additional app program 71 has been destroyed, with the use of a hash function (message digest algorithm 5 (MD5)) or the like. Installer 41 checks whether or not an electronic signature has been provided to additional app program 71. Installer 41 confirms that there is no destruction or no problem in the electronic signature, and thereafter installs the additional application. After installation is completed, additional app program 71 may be held as being encrypted.

License management unit 42 checks validity of license information 72 stored in additional app data unit 70 each time the installed additional application is executed by additional app control unit 50. For example, license management unit 42 determines whether or not the expiration date stored in license information 72 has come. When the expiration date has already come at the timing of request for execution of the additional application, additional app control unit 50 does not execute the additional application but shows the facility user that a problem of licensing has arisen.

Additional app control unit 50 controls the installed additional application. Specifically, additional app control unit 50 executes the program described as the additional application. The additional application is classified, for example, into an app to transmit an instruction to standard function control unit 30 to control operations of facility device 2 and an app not involved with operations of facility device 2 without transmission of an instruction to standard function control unit 30. In other words, the additional application includes an app affecting control of facility device 2 and an app not affecting control of facility device 2.

The app affecting control of facility device 2 will be described. The app affecting control of facility device 2 includes an app to optimize energy saving control or the like. Energy saving control is processing for optimizing the air-conditioning function for reduction of power consumption. More specifically, facility device 2A which is the air-conditioning device performs the heating function and the cooling function. In an example where facility device 2A is provided in an extremely cold region, the cooling function may hardly be used and the heating function may mainly be used. In an example where facility device 2A is provided in a tropical region, on the other hand, the heating function may hardly be used and the cooling function may mainly be used.

Usage of facility device 2A is thus different for each region. Consequently, processing contents in optimal energy saving control in facility device 2A are different for each management apparatus 3. For example, in an example where facility device 2A is used in the tropical region, the developer user creates an additional application for energy saving control specializing in use of the cooling function. This additional application transmits an instruction to standard function control unit 30 such that facility device 2A carries out energy saving control specializing in use of the cooling function.

Processing in facility device 2 controllable with the additional application may be restricted. For example, in an example where facility device 2 is the air-conditioning device to be used for a low-temperature storage for storage of perishable food, when the setting temperature of facility device 2 is high, great loss may be caused. Therefore, in the example where facility device 2 is the air-conditioning device to be used for the low-temperature storage, information for changing the setting temperature of facility device 2 is not published for the developer user or an upper limit value may be set for the setting temperature of facility device 2 controllable with the additional application.

At this time, the additional application transmits an instruction to standard function control unit 30 with the use of an application programing interface (API). The API is information on control of the standard function and information indicating what kind of instruction is to be transmitted to standard function control unit 30 to enable control of operations of each facility device 2. The API functions as an interface between the standard function and the additional application. The API is published on the Internet to the developer user authenticated by the manager of application distribution system 1. The API is thus published only to the developer user reliability of which was authenticated by the manager of application distribution system 1. The developer user can thus control standard function control unit 30 through the additional application. The API is published, for example, by distribution server 4. The published information includes a simulator for verification of execution of the additional application. The developer user can thus verify whether or not the additional application developed by the developer user himself/herself operates as he/she intended, or perform debugging or the like.

In succession, the app not affecting control of facility device 2 will be described. The app not affecting control of facility device 2 includes an app to refer to and monitor operating state data 61 to provide warning representation to the facility user. Such an additional application generates data based on operating state data 61 and shows the data to the facility user.

More specifically, operating state data 61 of facility device 2B which is the lighting device includes a duration of turn-on of facility device 2B. Turn-on even in daylight hours, of facility device 2B which is the facility device in a region where a sunshine duration is long may lead to waste of energy. For example, in the region where the sunshine duration is particularly long, the additional application compares the duration of turn-on of facility device 2B with the sunshine duration, and when facility device 2B is on even in daylight hours, it notifies the facility user of that fact.

Such an additional application does not transmit the instruction to standard function control unit 30 with the API but remains to refer to operating state data 61 and generate and show warning information. The additional application in the present embodiment thus includes applications to meet a wide variety of needs from a point of view of climates or cultures.

Management apparatus 3 can download a plurality of additional applications. For identification of the plurality of additional applications, an identification number is allocated to additional app program 71 for each additional application. The identification number of the additional app is stored for each additional app program 71 in additional app data unit 70. In an example where the plurality of additional applications have been installed in management apparatus 3, each additional application is executed independently of other additional applications. The additional application may be sold at cost or may be distributed at no charge.

Internet communication apparatus 90 transmits and receives data to and from distribution server 4 through communication line 6. Facility device communication apparatus 100 transmits and receives data to and from facility device 2 through dedicated communication line 5. In other words, Internet communication apparatus 90 and facility device communication apparatus 100 are each a communication interface.

### Configuration of Distribution Server

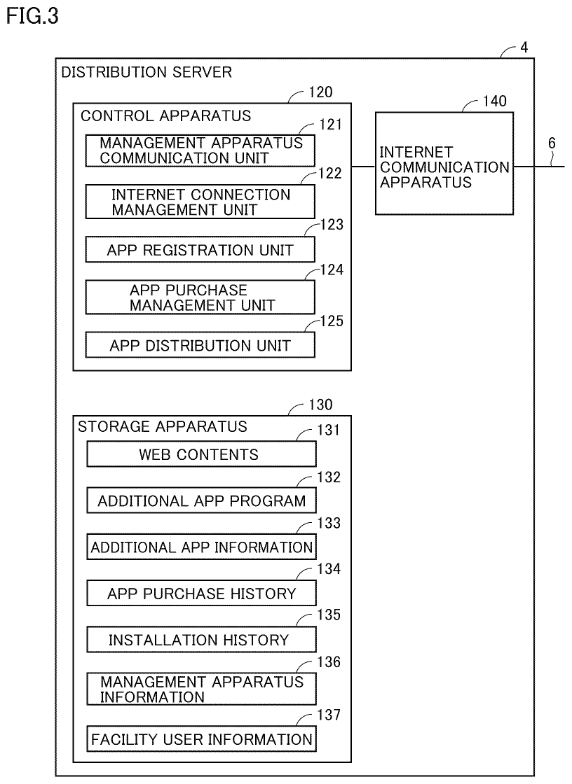

In succession, a configuration of distribution server 4 will be described. FIG. 3 is a block diagram showing an internal configuration of distribution server 4. Distribution server 4 manages in a centralized manner, the additional application to be distributed to management apparatus 3. As shown in FIG. 3, distribution server 4 includes a control apparatus 120, a storage apparatus 130, and an Internet communication apparatus 140.

Control apparatus 120 in distribution server 4 is similar in hardware configuration to control apparatus 11 in management apparatus 3 described above. Control apparatus 120 in distribution server 4 includes a management apparatus communication unit 121, an Internet connection management unit 122, an app registration unit 123, an app purchase management unit 124, and an app distribution unit 125.

Management apparatus communication unit 121 manages management apparatus 3 connectable to distribution server 4 through communication line 6 and communicates with the management apparatus. Management apparatus communication unit 121 manages each of a plurality of management apparatuses 3 connected to distribution server 4 such that each of them is identifiable. For example, management apparatus communication unit 121 uniquely determines management apparatus 3 to distribute the additional application when the facility user issues a request for installation of the additional application.

More specifically, when management apparatus communication unit 121 receives the request for installation of the additional application from the facility user, it obtains a production number of management apparatus 3 where the application is to be installed, that is included in the installation request. Management apparatus communication unit 121 compares the production number of management apparatus 3 stored in advance with the production number of management apparatus 3 installation in which is requested, and uniquely determines management apparatus 3 installation in which is requested.

Internet connection management unit 122 holds and manages a state of connection of distribution server 4 to the Internet. Distribution server 4 can thus distribute in real time, the additional application to management apparatus 3 where the application is to be installed, in response to issuance of a request for purchase or installation of the additional application from the facility user.

App registration unit 123 registers and manages the additional application developed by the developer user. Registration of the additional application in distribution server 4 is to authenticate the developer user who created the additional application and to allow distribution of the additional application to management apparatus 3. In other words, distribution server 4 places the additional application in condition for distribution to management apparatus 3 and has the additional application stored in storage apparatus 130 as an additional app program 132.

A request for registration of the additional application from the developer user to distribution server 4 will be referred to as a “registration request” below. In other words, when the developer user desires release of the additional application created by the developer user himself/herself, he/she issues the registration request to distribution server 4. In response to the registration request, only the additional application registered in distribution server 4 can be installed by the facility user. In issuing the registration request, the developer user transmits to distribution server 4, information such as a name of a producer of the developer user, overview of the additional app, version information, and a price of the app. The information such as the name of the producer of the developer user, the overview of the additional app, the version information, and the price of the app is stored in storage apparatus 130 as additional app information 133.

The additional application created by the developer user is thus registered in distribution server 4. In order to meet the needs arising in a single facility device alone, the facility user himself/herself who owns the facility device can thus develop an additional application to meet the needs. In this case, the facility user himself/herself is the developer user. Alternatively, the developer user can develop an additional application to meet the needs arising in a large number of facility devices and obtain usage fees from a plurality of facility users who use the additional application. Alternatively, the developer user may develop an additional application based on a request from the manager of application distribution system 1. In this case again, the developer user can obtain rewards from the manager of application distribution system 1 by developing the additional application. In other words, in any of the cases described above, the developer user can obtain profit by development of the additional application.

App purchase management unit 124 manages processing for purchase of the additional application by the facility user. When the facility user desires purchase of the additional application, the facility user transmits a purchase request for purchase of the additional application to distribution server 4 with the use of facility user terminal 9. Though the purchase request includes also a distribution request to distribute a free additional application, for the sake of brevity of description, the requests will collectively be referred to as a “purchase request” regardless of whether or not the additional application is free of charge. App purchase management unit 124 generates license information based on completion of a purchase procedure by the facility user. The license information includes a license number indicating permission of use of the additional application purchased by the facility user.

App purchase management unit 124 transmits the generated license information to the facility user who purchased the application. In addition, app purchase management unit 124 has the generated license information stored in storage apparatus 130 as an app purchase history 134. Distribution server 4 can thus determine whether or not the facility user who requests installation matches with the facility user who issued the purchase request as will be described later.

The facility user transmits the purchase request to distribution server 4, with a name of the facility user and the production number of management apparatus 3 used by the facility user being incorporated in the purchase request as facility user information. App purchase management unit 124 transmits the obtained facility user information to storage apparatus 130. Facility user information 137 is stored in storage apparatus 130.

When the facility user issues an installation request for installation of the additional application, app distribution unit 125 receives from the facility user, the license information including the production number of management apparatus 3 where the application is to be installed and the identification number of the additional application installation of which is requested. In other words, when the facility user issues the request for installation, it transmits to distribution server 4, the license information obtained by issuance of the purchase request.

App distribution unit 125 analyzes the license information included in the installation request and extracts the production number of management apparatus 3 and the identification number of the additional application. App distribution unit 125 determines whether or not the production number of management apparatus 3 and the identification number of the additional application extracted by analysis match with the license information generated at the time of the purchase request. After determination, app distribution unit 125 has the additional application and the license information stored in the public folder. Thereafter, app distribution unit 125 transmits an installation command and a license registration command to management apparatus 3, together with the URL of the public folder.

Storage apparatus 130 in distribution server 4 is similar in hardware configuration to storage apparatus 12 in management apparatus 3 described above. Web contents 131, additional app program 132, additional app information 133, app purchase history 134, an installation history 135, management apparatus information 136, and facility user information 137 are stored in storage apparatus 130.

Web contents 131 are web page information for purchase of an additional application. The facility user has web contents 131 shown on a web browser of facility user terminal 9. Web contents 131 include information on a list of a plurality of additional applications that can be added to management apparatus 3. Web contents 131 include the name of the producer of the developer user, the overview of the additional app, the version information, the price of the app, and the like included in additional app information 133.

On the web browser, each additional application can be shown as being classified for each type. For example, web contents 131 are shown in such a manner that apps relating to energy saving control, apps relating to collection of operation data, and the like are shown as being classified. On the web browser, the order of arrangement of the name, the price, the name of the producer, and the like of the additional app may be variable.

Additional app program 132 is an additional application developed by the developer user and registered by app registration unit 123. Additional app information 133 includes the name of the producer of the developer user, the overview of the additional app, the version information, the price of the app, and the like. App purchase history 134 includes the license information generated by app purchase management unit 124 and being identical to the license information transmitted to the facility user who has performed the purchase procedure.

Installation history 135 includes a history of distribution by app distribution unit 125. More specifically, time and date of transmission of the installation command from distribution server 4 to management apparatus 3, the production number of management apparatus 3 to which the installation command is directed, and information indicating whether or not installation in response to the installation command has been successful are stored in installation history 135.

Management apparatus information 136 includes the production number of each of management apparatuses 3 connected to distribution server 4. Facility user information 137 includes the name of the facility user and the production number of management apparatus 3 used by the facility user.

Internet communication apparatus 140 in distribution server 4 is a communication interface, similarly to Internet communication apparatus 90 in management apparatus 3 described above. Internet communication apparatus 140 transmits and receives data to and from management apparatus 3, developer user terminal 8, and facility user terminal 9 through communication line 6.

### Configuration of Developer User Terminal

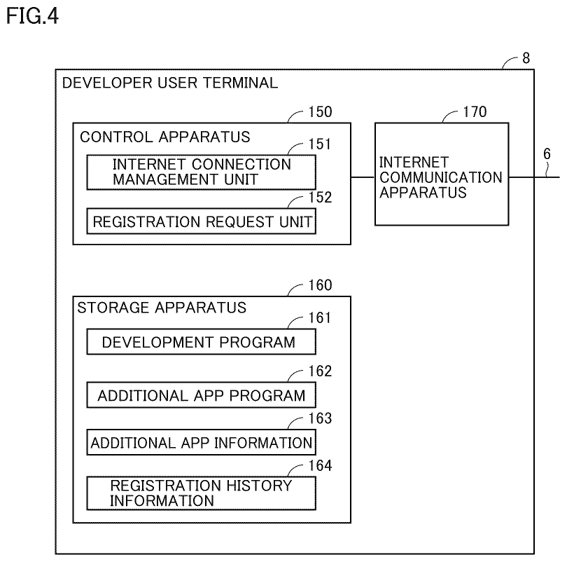

FIG. 4 is a block diagram showing an internal configuration of developer user terminal 8. Developer user terminal 8 is a terminal to be used by the developer user, and it is, for example, a PC with which an application can be developed. In other words, developer user terminal 8 provides a program development environment to the developer user. For registration of the additional application ready for release in distribution server 4, developer user terminal 8 transmits a registration request to distribution server 4.

Developer user terminal 8 includes a control apparatus 150, a storage apparatus 160, and an Internet communication apparatus 170. Control apparatus 150 in developer user terminal 8 is similar in hardware configuration to control apparatus 11 in management apparatus 3 described above. Storage apparatus 160 in developer user terminal 8 is similar in hardware configuration to storage apparatus 12 in management apparatus 3 described above.

Control apparatus 150 transmits an additional application to be registered and various types of information for registration of the additional application in distribution server 4. Control apparatus 150 includes an Internet connection management unit 151 and a registration request unit 152.

A development program 161, an additional app program 162, additional app information 163, and registration history information 164 are stored in storage apparatus 160. Development program 161 is, for example, an integrated development environment for support of development of an additional application. A type and a product name of the integrated development environment to be used as development program 161 are published by the manager of application distribution system 1.

More specifically, a recommended integrated development environment is included in web contents 131 in distribution server 4, as information for a developer of the additional application. Therefore, the developer user can specify the type of the integrated development environment by accessing web contents 131 in distribution server 4. In other words, the developer user can use the integrated development environment used as development program 161 for development of the additional application. Web contents 131 may include specifications or the like for development of the additional application, in addition to the recommended integrated development environment. Thus, in application distribution system 1, such information as the recommended integrated development environment is published to the public as information for developers of additional applications, so that a developer population can be increased.

Additional app program 162 shown in FIG. 4 is an additional application developed with the use of development program 161 and being ready for release. The developer user develops an additional application to meet various needs for each management apparatus provided in each region. The developer user provides an electronic signature issued by an external authentication authority to the additional application ready for release. Persons other than the developer user can thus confirm reliability of the producer of the additional application by checking the electronic signature provided to the additional application. Additional app information 163 is information such as the name of the producer of the developer user, the overview of the additional app, the version information, and the price of the app, and it is inputted by the developer user.

Registration history information 164 includes information on a history of registration of additional app program 162 in distribution server 4. For example, registration history information 164 includes the name of the registered additional app program, time and date of registration, and the like.

Internet connection management unit 151 in control apparatus 150 performs processing for connection of developer user terminal 8 to the Internet. Registration request unit 152 transmits the registration request to distribution server 4. In other words, when the developer user requests registration of the additional application ready for release in distribution server 4, registration request unit 152 transmits the registration request to distribution server 4. At this time, registration request unit 152 transmits additional app program 162 stored in storage apparatus 160, registration of which is requested, and additional app information 163. Thereafter, when the additional application is registered in distribution server 4, control apparatus 150 updates registration history information 164.

Developer user terminal 8 can develop a plurality of additional applications. In this case, additional app programs 162 as many as developed additional applications and additional app information 163 are stored in storage apparatus 160. In an example where a plurality of developer users develop a single additional application, developer user terminal 8 may include at least two terminals.

Internet communication apparatus 170 in developer user terminal 8 is a communication interface, similarly to Internet communication apparatus 90 in management apparatus 3 described above. Internet communication apparatus 170 transmits and receives data to and from distribution server 4 through communication line 6.

### Configuration of Facility User Terminal

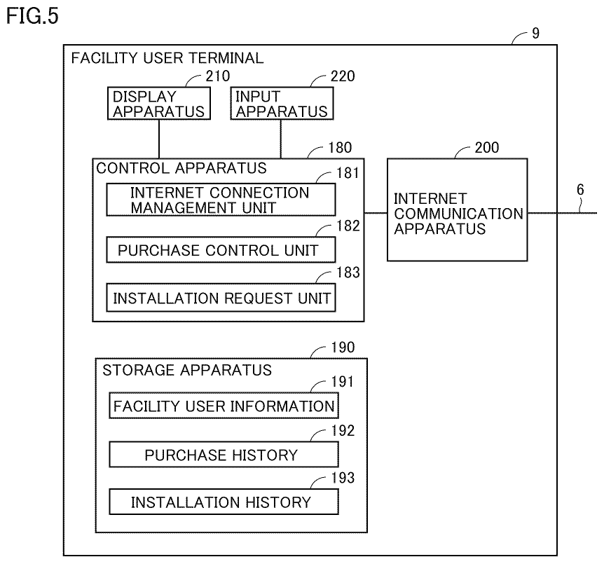

FIG. 5 is a block diagram showing an internal configuration of facility user terminal 9. Facility user terminal 9 is a terminal for issuance of a request for purchase and installation of an additional app distributed by distribution server 4. For example, facility user terminal 9 may be a smartphone or a general-purpose PC on which a web browser can be started up.

Facility user terminal 9 includes a control apparatus 180, a storage apparatus 190, an Internet communication apparatus 200, a display apparatus 210, and an input apparatus 220.

Control apparatus 180, storage apparatus 190, display apparatus 210, and input apparatus 220 in facility user terminal 9 are similar in hardware configuration to control apparatus 11, storage apparatus 12, display apparatus 10, and input apparatus 20 in management apparatus 3 described above, respectively.

Control apparatus 180 includes an Internet connection management unit 181, a purchase control unit 182, and an installation request unit 183. Facility user information 191, a purchase history 192, and an installation history 193 are stored in storage apparatus 190.

Internet connection management unit 181 in control apparatus 180 manages connection of facility user terminal 9 to the Internet through Internet communication apparatus 200. Purchase control unit 182 in control apparatus 180 transmits facility user information 191 to distribution server 4 in purchase of an additional application. Facility user information 181 is inputted by the facility user and stored in storage apparatus 190.

When the facility user purchases an additional application, it accesses web contents 131 in distribution server 4. Distribution server 4 has the facility user select the additional application which the facility user desires to purchase. Distribution server 4 has the facility user input the production number of management apparatus 3 in which the selected additional application is to be installed. Information on the purchased additional application and the production number of management apparatus 3 in which the purchased additional application is to be installed can be stored in distribution server 4 in association with each other. Distribution server 4 generates license information based on the information on the additional application and the production number of management apparatus 3, and transmits the license information to facility user terminal 9. Facility user terminal 9 has the transmitted license information stored in storage apparatus 190, with the license information being incorporated in purchase history 192.

When processing for purchase of the additional application is completed, purchase control unit 182 has purchase history information such as time and date of purchase in addition to the license information stored in storage apparatus 190 as purchase history 192.

For installation of the purchased additional application in management apparatus 3, installation request unit 183 transmits an installation request to distribution server 4. At this time, installation request unit 183 transmits to distribution server 4, the production number of management apparatus 3 where the application is to be installed, with the production number being incorporated in the installation request. After installation processing is completed, installation request unit 183 has information on whether or not installation has been successful stored in storage apparatus 190 as installation history 193. Installation history 193 includes the production number of management apparatus 3 installation in which is requested, time and date of installation, the name of the additional application, the identification number, and the like.

Internet communication apparatus 200 in facility user terminal 9 is a communication interface, similarly to Internet communication apparatus 90 in management apparatus 3 described above. Internet communication apparatus 200 transmits and receives data to and from management apparatus 3 and distribution server 4 through communication line 6.

### Registration Processing

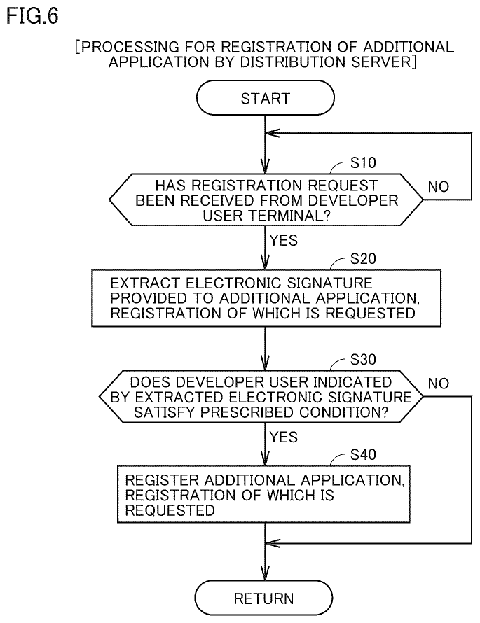

A flow of processing performed in the present embodiment is shown in a flowchart in FIGS. 6 to 9 below. FIG. 6 is a flowchart showing a processing for registration of an additional application by distribution server 4.

Distribution server 4 determines whether or not it has received the registration request from developer user terminal 8 (step S10). When distribution server 4 has not received the registration request from developer user terminal 8 (NO in step S10), it repeats processing in step S10.

When distribution server 4 has received the registration request from developer user terminal 8 (YES in step S10), it extracts the electronic signature provided to the additional application registration of which is requested (step S20). Distribution server 4 determines whether or not the developer user indicated by the extracted electronic signature satisfies a prescribed condition (step S30).

Specifically, distribution server 4 checks reliability of the developer user who provided the extracted electronic signature, and when reliability satisfies the prescribed condition, the distribution server authenticates the developer user. More specifically, distribution server 4 makes an inquiry to an external authentication authority and checks whether or not the developer user who provided the electronic signature is included in a list of predetermined highly reliable developer users. When the developer user is included in the highly reliable developer users, distribution server 4 authenticates the developer user indicated by the electronic signature. In this case, the prescribed condition is inclusion of the developer user in the predetermined list.

When the developer user satisfies the prescribed condition (YES in step S30), distribution server 4 registers the additional application registration of which is requested (step S40). In other words, app registration unit 123 of distribution server 4 performs registration processing so that the additional application is registered as the additional app program in storage apparatus 130. The additional application developed by the developer user is thus registered in distribution server 4, so that the facility user can purchase the registered application and issue the request for installation thereof. When the developer user does not satisfy the prescribed condition (NO in step S30), distribution server 4 quits the process without registering the additional application registration of which is requested.

In step S40, only the additional application security of which is confirmed by the manager of application distribution system 1 may be registered. In other words, when the developer user satisfies the prescribed condition (YES in step S30), distribution server 4 registers the additional application based on acceptance from the manager of application distribution system 1, of information indicating that security of the additional application has been confirmed. In application distribution system 1, only the additional application security of which has been confirmed as a result of examination can thus be registered.

In application distribution system 1 in the present embodiment, the additional application may be registered in distribution server 4 on condition that the developer user performs charging processing. Specifically, the developer user pays fees for registration of the additional application and fees for examination to the manager of application distribution system 1.

In one aspect, an upper limit may be set for a data size of the additional application to be registered. In application distribution system 1, occupation by the additional application, of a memory area of management apparatus 3 in which the additional application is installed can thus be suppressed.

### Purchase Processing

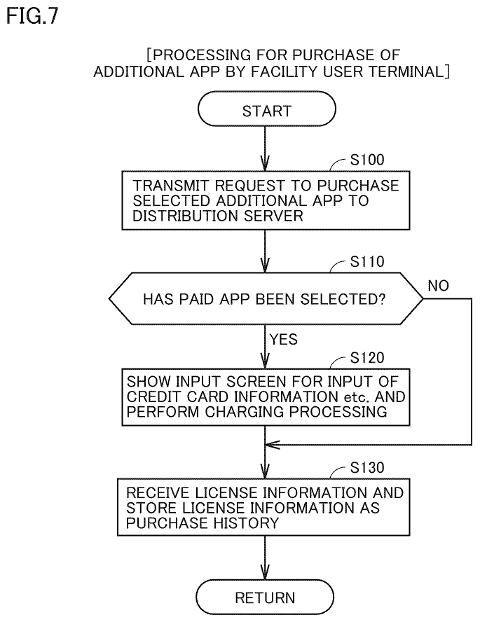

FIG. 7 is a flowchart showing processing for purchase of an additional application by facility user terminal 9. By being operated by the facility user, facility user terminal 9 accesses web contents 131 in distribution server 4 through the web browser. The additional application that can be purchased is published on a web page owned by the manager of application distribution system 1 and published to the public without access restriction. The facility user selects an additional application the facility user desires to purchase, from a list of additional applications included in web contents 131. In response to selection of the additional application the facility user desires to purchase, facility user terminal 9 transmits a purchase request to purchase the selected additional application to distribution server 4 (step S100). At this time, facility user terminal 9 transmits the facility user information, with the facility user information being incorporated in the purchase request to purchase the additional application.

Facility user terminal 9 determines whether or not a paid app has been selected (step S110). When the facility user terminal has selected the paid app (YES in step S110), charging processing is requested from distribution server 4 to facility user terminal 9, and hence facility user terminal 9 shows an input screen for input of credit card information or the like and performs the charging processing (step S120). The charging processing is not limited to the charging processing in which a credit card is used, and it may be charging processing for deduction of a price from a bank account registered in advance for each facility user. Distribution server 4 may set subscription as a type of sales of an additional application. When the paid app has not been selected (NO in step S110), facility user terminal 9 has the process proceed to step S130 without performing the charging processing.

When the charging processing is performed, distribution server 4 generates the license information based on the facility user information included in the purchase request in step S100. Thereafter, distribution server 4 transmits the generated license information to facility user terminal 9. The license information transmitted from distribution server 4 is stored in facility user terminal 9 as the purchase history (step S130). At this time, the license information incorporating also time and date of purchase or the like is stored in facility user terminal 9 as the purchase history.

### Installation Processing

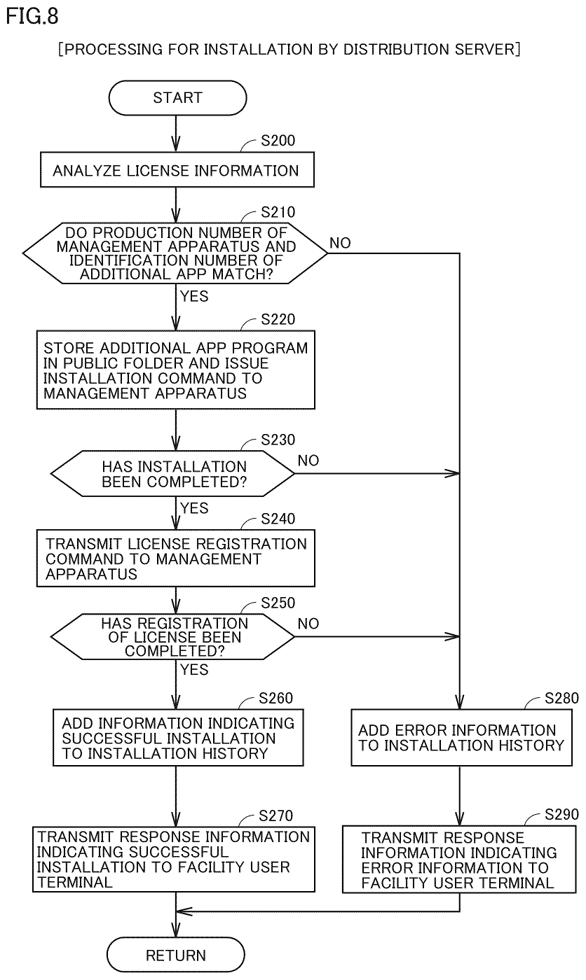

FIG. 8 is a flowchart showing processing for installation of an additional application by distribution server 4. As described with reference to FIG. 7, the facility user can issue the installation request to install the additional application for which the purchase processing has been completed. As described above, when the facility user issues the installation request, facility user terminal 9 transmits the license information to distribution server 4.

Distribution server 4 analyzes the license information included in the installation request (step S200). Distribution server 4 determines whether or not the production number of management apparatus 3 and the identification number of the additional application extracted by analysis match with the license information generated at the time of the purchase request (step S210). When there is no match of the license information, the license information may have been tampered. Therefore, when there is no match of the license information (NO in step S210), distribution server 4 adds the license information which did not match to installation history 135 as error information (step S280), transmits response information indicating the error information to facility user terminal 9 (step S290), and quits the process without transmitting the installation command. The response information includes the production number and the identification number of the additional application extracted by analysis of the license information.

When there is match of the license information (YES in step S210), distribution server 4 has additional app program 132 stored in the public folder and transmits the installation command to management apparatus 3 (step S220). Thereafter, after management apparatus 3 accesses the URL of the public folder and installation is completed, it transmits a message indicating completion of installation to distribution server 4.

Distribution server 4 determines whether or not installation has been completed based on whether or not it has received from management apparatus 3, a message indicating appropriate completion of installation (step S230). When distribution server 4 has not received from management apparatus 3, the message indicating appropriate completion of installation (NO in step S230), it adds the error information received from management apparatus 3 to installation history 135 (step S280), transmits the response information indicating the error information to facility user terminal 9 (step S290), and quits the process.

When distribution server 4 has received from management apparatus 3, the message indicating appropriate completion of installation (YES in step S230), it transmits a license registration command to management apparatus 3 (step S240). In other words, distribution server 4 transmits the license information transmitted from facility user terminal 9 in step S200 to management apparatus 3. Management apparatus 3 has the received license information stored in additional app data unit 70 as license information 72. Based on storage as license information 72 in additional app data unit 70, management apparatus 3 transmits information indicating completion of license registration to distribution server 4.

Distribution server 4 determines whether or not license registration has been completed based on whether or not it has received information indicating appropriate completion of license registration from management apparatus 3 (step S250). When license registration has not been completed (NO in step S250), distribution server 4 adds the error information received from management apparatus 3 to installation history 135 (step S280), transmits the response information indicating the error information to facility user terminal 9 (step S290), and quits the process.

When license registration has been completed (YES in step S250), distribution server 4 adds information indicating successful installation to installation history 135 (step S260), transmits the response information indicating successful installation to facility user terminal 9 (step S270), and quits the process.

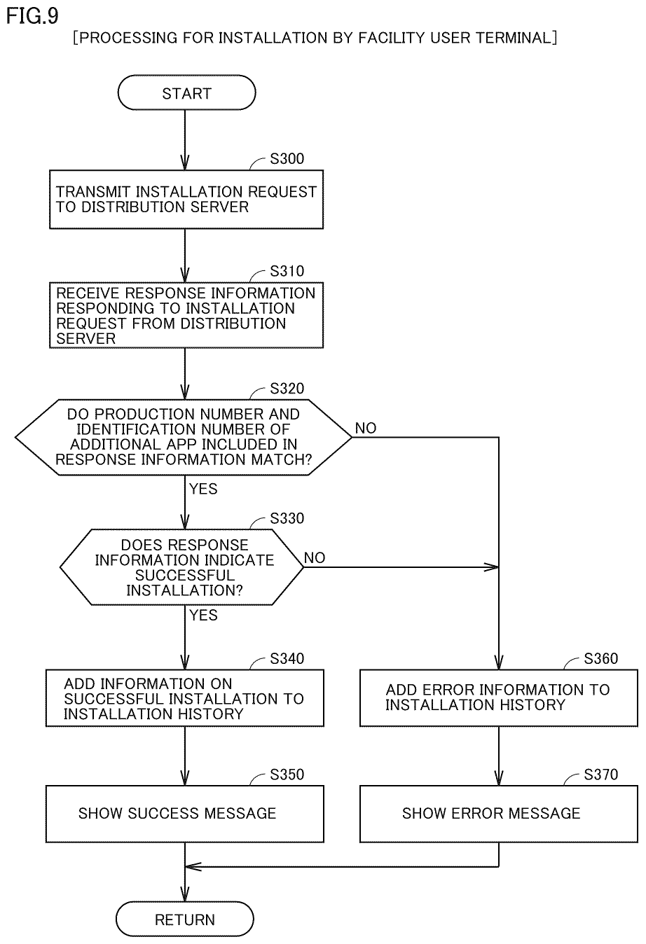

FIG. 9 is a flowchart showing processing for installation of an additional application by facility user terminal 9. When the facility user requests installation of the additional application for which purchase processing has been completed, facility user terminal 9 transmits the installation request to distribution server 4 (step S300). More specifically, facility user terminal 9 accepts the installation request from the facility user through input apparatus 220. Facility user terminal 9 transmits the license information stored in step S130 in FIG. 7 to distribution server 4.

After facility user terminal 9 transmits the installation request, it receives the response information from distribution server 4. Specifically, facility user terminal 9 receives the response information transmitted from distribution server 4 in step S270 or step S290 in FIG. 8 (step S310). Facility user terminal 9 determines whether or not the production number of management apparatus 3 and the identification number of the additional application included in the response information match with the production number and the identification number in the license information included in the installation request in step S300 (step S320).

When the production numbers and the identification numbers do not match (NO in step S320), facility user terminal 9 adds the error information to installation history 193 assuming that it has received the response information not corresponding to the installation request (step S360) and shows an error message on display apparatus 210 (step S370).

When the production numbers and the identification numbers match (YES in step S320), facility user terminal 9 determines whether or not the response information indicates successful installation (step S330). When the response information does not indicate successful installation but indicates the error information (NO in step S330), facility user terminal 9 adds the error information to installation history 193 (step S360) and shows the error message on display apparatus 210 (step S370). When the response information indicates the error information in step S330, distribution server 4 has transmitted the response information to facility user terminal 9 in processing in step S290 in FIG. 8.

When the response information indicates successful installation (YES in step S330), facility user terminal 9 adds information on successful installation to installation history 193 (step S340) and shows a message indicating successful installation on display apparatus 210 (step S350). When the response information indicates successful installation in step S330, distribution server 4 has transmitted the response information to facility user terminal 9 in processing in step S270 in FIG. 8.

When such a defect as a bug is found after installation of the additional application, the manager of application distribution system 1 contacts the developer user about the defect. The developer user fixes the additional application based on the contact and again issues the registration request. When the defect is found, the manager of application distribution system 1 identifies based on the license information, the facility user who uses the management apparatus in which the additional application where the defect was found had been installed, and urges the facility user to stop using the additional application.

Thus, in application distribution system 1 in the present embodiment, separately from a standard control function to control operations of facility device 2, the additional application is installed in management apparatus 3. An application that allows expansion of a management function can be distributed to management apparatus 3 to manage facility device 2 for each management apparatus 3. Since the facility user can issue the installation request to install the additional application through facility user terminal 9, the facility user alone can perform installation processing in application distribution system 1, and a request for dispatch of a worker or the like for management apparatus 3 does not have to be issued.

According to application distribution system 1, the additional application does not affect data relating to the standard function. Therefore, development of the additional application can be recommended to persons other than the manager of application distribution system 1, and development of a wide variety of additional applications in accordance with demands from markets can be promoted. Furthermore, with increase in developer population and competition among developer users, a period of development of an additional application desired by the facility user becomes shorter. According to application distribution system 1, the manager of application distribution system I can charge a registration fee for registration of the additional application to the developer user.

The configuration in which application distribution system 1 in the present embodiment includes developer user terminal 8 and facility user terminal 9 is described. In one aspect, management apparatus 3 may issue the registration request and the installation request. Specifically, the facility user accesses web contents 131 from management apparatus 3 and transmits the installation request with the use of input apparatus 20. Management apparatus 3 may accept the installation command and the license registration command with the use of a USB memory or the like, rather than receiving the installation command and the license registration command from distribution server 4 over the network.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

1 application distribution system; 2, 2A to 2F facility device; 3, 3A, 3B management apparatus; 4 distribution server; 5, 5A, 5B dedicated communication line; 6 communication line; 7, 7A, 7B facility device group; 8 developer user terminal; 9 facility user terminal; 10, 210 display apparatus; 11, 120, 150, 180 control apparatus; 12, 130, 160, 190 storage apparatus; 20, 220 input apparatus; 30 standard function control unit; 31, 122, 151, 181 Internet connection management unit; 40 additional app management unit; 41 installer; 42 license management unit; 50 additional app control unit; 61 operating state data; 60 standard function data unit; 62 facility device information; 63 system configuration information; 70 additional app data unit; 71, 132, 162 additional app program; 72, 73 license information; 90, 140, 170, 200 Internet communication apparatus; 100 facility device communication apparatus; 121 management apparatus communication unit; 123 app registration unit; 124 app purchase management unit; 125 app distribution unit; 126 purchase history management unit; 131 web contents; 133, 163 additional app information; 134 app purchase history; 135, 193 installation history; 136 management apparatus information; 137, 191 facility user information; 152 registration request unit; 161 development program; 164 registration history information; 182 purchase control unit; 183 installation request unit; 192 purchase history.

1. An application distribution system comprising:
a management apparatus to manage a facility device to be used by a facility user; and
a distribution server connected to the management apparatus over a network, wherein
the management apparatus is configured to perform a standard function to control operations of the facility device,
an additional application is installed in the management apparatus, the additional application being a function different from the standard function and being configured to perform processing with data on the facility device collected by the standard function, and
the distribution server is configured to
receive the additional application developed by a developer user over a network, and
install the received additional application on the management apparatus, wherein
information on control of the standard function is available, and
the processing performed by the additional application comprises processing for controlling operations of the facility device in accordance with the information on control of the standard function.

2. The application distribution system according to claim 1, further comprising a facility user terminal to communicate with the distribution server, wherein
the facility user terminal is configured to transmit to the distribution server, an installation request for installation of the additional application in the management apparatus, and
the distribution server is configured to transmit the additional application to the management apparatus in response to the installation request.

3. The application distribution system according to claim 2, further comprising a developer user terminal to communicate with the distribution server, wherein
the developer user terminal is configured to transmit to the distribution server, a registration request for registration of the additional application in the distribution server, and
the distribution server is configured to register the additional application in response to the registration request.

4. The application distribution system according to claim 3, wherein
the additional application is provided with an electronic signature by the developer user, and
the distribution server is configured to authenticate the developer user with the electronic signature in response to reception of the registration request.

5. The application distribution system according to claim 2, wherein
the distribution server is configured to generate license information indicating permission to use of the additional application and provides the license information to the facility user,
the installation request includes the license information generated by the distribution server, and
the distribution server is configured to
determine whether the license information included in the installation request matches with the license information provided by the distribution server, in response to reception of the installation request, and
transmit an installation command for installation of the additional application in the management apparatus to the management apparatus when the license information included in the installation request matches with the license information provided by the distribution server.

6. The application distribution system according to claim 5, wherein
the distribution server is configured to transmit response information indicating occurrence of an error to the facility user when the license information included in the installation request does not match with the license information provided by the distribution server.

7. The application distribution system according to claim 5, wherein
the distribution server is configured to transmit a license registration command including the license information to the management apparatus based on transmission of the installation command.

8. (canceled)

9. The application distribution system according to claim 3, wherein
the additional application is developed by a defined development program, and
the defined development program is available to the developer user.

10. The application distribution system according to claim 3, wherein the distribution server is configured to perform charging processing for charging the developer user in response to issuance of the registration request for registration of the additional application.

11. The application distribution system according to claim 1, wherein
the facility device is an air-conditioning device to perform an air-conditioning function, and
the processing performed by the additional application is processing for optimizing the air-conditioning function for reduction of power consumption by the facility device.

12. A management apparatus to manage a facility device to be used by a facility user, the management apparatus being connected to a distribution server over a network, the management apparatus comprising:
a communication apparatus to communicate with the facility device; and
a control apparatus, wherein
the control apparatus is configured to
perform a standard function to control operations of the facility device, and
receive an additional application from the distribution server and has the additional application installed, the additional application being a function different from the standard function and being configured to perform processing with data on the facility device collected by the standard function
wherein
information on control of the standard function is available, and
the processing performed by the additional application comprises processing for controlling operations of the facility device in accordance with the information on control of the standard function.

13. The management apparatus according to claim 1211, wherein
the control apparatus is configured to
transmit to the distribution server, an installation request for installation of the additional application in the management apparatus, and
have the additional application installed in response to reception from the distribution server, of an installation command for installation of the additional application in the management apparatus.

14. An additional application distribution method comprising:
installing an additional application in a management apparatus to perform a standard function, the additional application being a function different from the standard function and being configured to perform processing with data on the facility device collected by the standard function;
publishing information on control of a standard function to control operations of a facility device to a developer user who develops the additional application;
registering the additional application created by the developer user in a distribution server based on control of the published standard function;
transmitting to the distribution server, by a facility user who uses the facility device, an installation request for installation of the additional application registered in the distribution server; and
installing the additional application in the management apparatus based on transmission of the installation request.
